(19) United States
(12) Patent Application Publication
(10) Pub. No.: US 2025/0371549 A1
(43) Pub. Date: Dec. 4, 2025

(54) RISK FEATURE DESCRIPTION EXTRACTION

(71) Applicant: Alipay (Hangzhou) Information Technology Co., Ltd., Hangzhou (CN)

(72) Inventor: Yang YANG, Hangzhou (CN)

(21) Appl. No.: 18/872,600

(22) PCT Filed: May 19, 2023
(86) PCT No.: PCT/CN2023/095193

§ 371 Date: Dec. 6, 2024

(30) Foreign Application Priority Data
Jun. 22, 2022 (CN) 202210710741.3

(51) Int. Cl. G06Q 20/40

(52) U.S. Cl. CPC G06Q 20/4016

(57) ABSTRACT

Embodiments of this specification describe a risk feature description extraction method and apparatus. In the method in the embodiments, risk transaction data for risk transaction prediction are obtained, and random transaction data are randomly obtained from transaction record data. Then, the risk transaction data and the random transaction data are separately input into a risk transaction prediction model, and respective transaction representation is output by a neuron layer that is not an output layer of the risk transaction prediction model. Further, a risk feature description capable of being used to perform risk determining can be determined based on importance of each obtained transaction representation in determining whether a risk transaction has a risk.

### TECHNICAL FIELD

One or more embodiments of this specification relate to the field of computer technologies, and in particular, to risk feature description extraction.

### BACKGROUND

Currently, a prediction model based on a neural network is widely applied to various service scenarios. For example, in the financial field, the risk prediction model can predict a risk behavior, a risk account, etc., to control the risk behavior and the risk account, and improve security of a financial transaction.

However, the neural network has a feature of a black box, and an easy-to-understand interpretation of a prediction result cannot be provided. Consequently, a risk behavior cannot be prevented, controlled, or coped with more purposefully. Therefore, a feature description extraction solution for a feature descriptions for the risk transaction prediction model, to interpret a prediction result of the risk transaction prediction model.

### SUMMARY

One or more embodiments of this specification describe a risk feature description extraction method and apparatus, to extract a risk feature description for performing transaction risk determining.

According to a first aspect, a risk feature description extraction method is provided, including: obtaining at least one group of risk transaction data for risk transaction prediction, where each group of risk transaction data satisfy one risk feature description; obtaining at least one group of random transaction data from transaction record data of a historical risk control event; separately inputting the at least one group of risk transaction data and the at least one group of random transaction data into a pre-trained risk transaction prediction model, to obtain at least one risk transaction representation corresponding to the risk transaction data and at least one random transaction representation corresponding to the random transaction data that are output by a first neuron layer of the risk transaction prediction model, where the risk transaction prediction model is used to predict whether a transaction has a risk, and the first neuron layer is not an output layer of the risk transaction prediction model; and determining, based on importance of the at least one risk transaction representation and the at least one random transaction representation in determining whether a risk transaction has a risk, a risk feature description capable of being used to perform transaction risk determining in all risk feature descriptions.

In a possible implementation, the obtaining at least one group of risk transaction data for risk transaction prediction includes: pre-determining at least one initial risk feature description that describes a transaction event, where each initial risk feature description includes at least one variable first parameter, and the first parameter includes at least one of a time, a place, and a transaction amount of a transaction; for each initial risk feature description, performing value traversal on the first parameter in the initial risk feature description based on a preset parameter traversal range, to generate a traversal risk feature description; and obtaining risk transaction data corresponding to each risk feature description based on the initial risk feature description and each traversal risk feature description.

In a possible implementation, the obtaining risk transaction data corresponding to each risk feature description based on the initial risk feature description and each traversal risk feature description includes: converting the initial risk feature description and the traversal risk feature description into an SQL statement; and querying a transaction database based on the SQL statement, to obtain risk transaction data that satisfy each risk feature description; and/or randomly generating risk transaction data that satisfy the initial risk feature description; and randomly generating risk transaction data that satisfy the traversal risk feature description.

In a possible implementation, the determining, based on importance of the at least one risk transaction representation and the at least one random transaction representation in determining whether a risk transaction has a risk, a risk feature description capable of being used to perform transaction risk determining in all risk feature descriptions includes: training a linear model based on the risk transaction representation and the random transaction representation, where the linear model is used to classify the risk transaction representation and the random transaction representation into two different spaces; determining an orthogonal direction corresponding to the linear model as a normal direction of an interface for distinguishing the risk transaction representation and the random transaction representation; and for each of the risk transaction representations, performing the following operations: obtaining a final representation that is of a current risk transaction representation and that is output by the output layer of the risk transaction prediction model; computing a partial derivative that is of the current risk transaction representation and that is obtained based on the final expression; and determining, based on a partial derivative obtained based on each risk transaction representation and the normal direction of the interface, a risk feature description capable of being used to perform transaction risk determining.

In a possible implementation, the computing a partial derivative that is of the current risk transaction representation and that is obtained based on the final expression includes: computing, based on the following computing formula, the partial derivative that is of the current risk transaction representation and that is obtained based on the final expression:

$$S = ∇ h ( f ( x ) )$$

S is used to represent the partial derivative that is of the current risk transaction representation and that is obtained based on the final expression of the current risk transaction representation, h is used to represent the final expression of the current risk transaction representation, f(x) is used to represent the current risk transaction representation, and x is used to represent a risk feature description corresponding to the current risk transaction representation.

In a possible implementation, the normal direction of the interface points to a direction of a space in which the risk transaction representation is located; and the determining, based on a partial derivative obtained based on each risk transaction representation and the normal direction of the interface, a risk feature description capable of being used to perform transaction risk determining includes: separately determining whether a direction of the partial derivative obtained based on each risk transaction representation is consistent with the normal direction of the interface; and if a direction of a partial derivative obtained based on a risk transaction representation is consistent with the normal direction of the interface, determining a risk feature description corresponding to the risk transaction representation as a risk feature description capable of being used to perform transaction risk determining.

According to a second aspect, a risk feature description extraction apparatus is provided, including: a risk transaction data obtaining module, a random transaction data obtaining module, a model output module, and a risk feature description determining module. The risk transaction data obtaining module is configured to obtain at least one group of risk transaction data for risk transaction prediction. Each group of risk transaction data satisfy one risk feature description. The random transaction data obtaining module is configured to obtain at least one group of random transaction data from transaction record data of a historical risk control event. The model output module is configured to separately input the at least one group of risk transaction data obtained by the risk transaction data obtaining module and the at least one group of random transaction data obtained by the random transaction data obtaining module into a pre-trained risk transaction prediction model, to obtain at least one risk transaction representation corresponding to the risk transaction data and at least one random transaction representation corresponding to the random transaction data that are output by a first neuron layer of the risk transaction prediction model, where the risk transaction prediction model is used to predict whether a transaction has a risk, and the first neuron layer is not an output layer of the risk transaction prediction model. The risk feature description determining module is configured to determine, based on importance of the at least one risk transaction representation and the at least one random transaction representation that are output by the model output module in determining whether a risk transaction has a risk, a risk feature description capable of being used to perform transaction risk determining in all risk feature descriptions.

In a possible implementation, when obtaining the at least one group of risk transaction data for risk transaction prediction, the risk transaction data obtaining module is configured to perform the following operations: pre-determining at least one initial risk feature description that describes a transaction event, where each initial risk feature description includes at least one variable first parameter, and the first parameter includes at least one of a time, a place, and a transaction amount of a transaction; for each initial risk feature description, performing value traversal on the first parameter in the initial risk feature description based on a preset parameter traversal range, to generate a traversal risk feature description; and obtaining risk transaction data corresponding to each risk feature description based on the initial risk feature description and each traversal risk feature description.

According to a third aspect, a computing device is provided, including a memory and a processor. The memory stores executable code, and when the processor executes the executable code, the method in any implementation of the first aspect is implemented.

According to a fourth aspect, a non-transitory computer-readable storage medium is provided. The computer-readable storage medium stores a computer program. When the computer program is executed on a computer, the computer is enabled to perform the method in any implementation of the first aspect.

According to the method and the apparatus provided in the embodiments of the specification, when the risk feature description is extracted, risk transaction data for risk transaction prediction are obtained, and random transaction data are obtained from transaction record data. Then, the obtained risk transaction data and the obtained random transaction data are separately input into the risk transaction prediction model, and a risk transaction representation corresponding to the risk transaction data and a random transaction representation corresponding to the random transaction data are output by a first neuron layer of the risk transaction prediction model. Further, a risk feature description capable of being used to perform transaction risk determining can be determined based on importance of the risk transaction representation and the random transaction data in determining whether the risk transaction has a risk. It can be learned that the risk transaction representation in this solution is obtained based on transaction data that satisfy some risk feature descriptions, and the random transaction representation is obtained based on randomly obtained transaction data. In this way, degrees of importance of the risk transaction representation and the random transaction representation are significantly different, and the risk feature description capable of being used to perform transaction risk determining can be obtained based on this.

### BRIEF DESCRIPTION OF DRAWINGS

To describe technical solutions in embodiments of this specification or in a conventional technology more clearly, the following briefly describes accompanying drawings needed for describing the embodiments or the conventional technology. Clearly, the accompanying drawings in the following descriptions show some embodiments of this specification, and a person of ordinary skill in the art can still derive other drawings from these accompanying drawings without creative efforts.

FIG. 1 is a flowchart of a risk feature description extraction method according to one or more embodiments of this specification;

FIG. 2 is a flowchart of a risk transaction data obtaining method according to one or more embodiments of this specification;

FIG. 3 is a flowchart of another risk feature description extraction method according to one or more embodiments of this specification;

FIG. 4 is a schematic diagram of classifying a risk transaction representation and a random transaction representation according to one or more embodiments of this specification; and

FIG. 5 is a schematic diagram of a risk feature description extraction apparatus according to one or more embodiments of this specification.

### DESCRIPTION OF EMBODIMENTS

As described above, currently, prediction models based on neural networks are widely applied to various service scenarios, and have relatively good performance. For example, a risk transaction behavior is predicted in a risk control scenario, environment temperatures and humidity are predicted in environment prediction, and a vehicle track is predicted.

However, the neural network has a feature of a black box, and an easy-to-understand interpretation of a prediction result obtained by the prediction model cannot be provided. For example, when a risk transaction is predicted, when a risk transaction prediction model predicts that a transaction account has a risk, specific features, in transaction data, based on which the risk transaction prediction model predicts that the transaction account has a risk cannot be learned of, for example, a transaction amount in a period of time in the transaction data, a transaction quantity in a period of time, or N consecutive transactions involving multiples of 100. Therefore, although the prediction model can provide the prediction result, the prediction model cannot learn of whether predictability of the prediction result is good, and consequently, cannot take prevention and control and coping measures more purposeful.

Based on this, it is considered in this solution that transaction data that satisfy a specific risk feature description and randomly obtained transaction data are separately represented by using the prediction model, and then a risk feature description capable of being used to perform transaction risk determining is determined based on degrees of importance of the transaction data in determining whether a risk transaction has a risk.

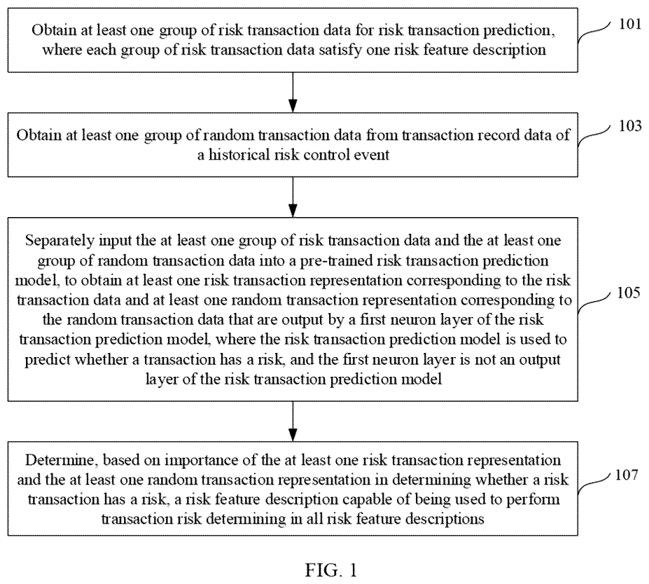

As shown in FIG. 1, one or more embodiments of this specification provide a risk feature description extraction method. The method can include the following steps. Step 101: Obtain at least one group of risk transaction data for risk transaction prediction, where each group of risk transaction data satisfy one risk feature description. Step 103: Obtain at least one group of random transaction data from transaction record data of a historical risk control event. Step 105: Separately input the at least one group of risk transaction data and the at least one group of random transaction data into a pre-trained risk transaction prediction model, to obtain at least one risk transaction representation corresponding to the risk transaction data and at least one random transaction representation corresponding to the random transaction data that are output by a first neuron layer of the risk transaction prediction model, where the risk transaction prediction model is used to predict whether a transaction has a risk, and the first neuron layer is not an output layer of the risk transaction prediction model. Step 107: Determine, based on importance of the at least one risk transaction representation and the at least one random transaction representation in determining whether a risk transaction has a risk, a risk feature description capable of being used to perform transaction risk determining in all risk feature descriptions.

In this embodiment, when the risk feature description is extracted, the risk transaction data for risk transaction prediction are obtained, and the random transaction data are obtained from transaction record data. Then, the obtained risk transaction data and the obtained random transaction data are separately input into the risk transaction prediction model, and the risk transaction representation corresponding to the risk transaction data and the random transaction representation corresponding to the random transaction data are output by a first neuron layer of the risk transaction prediction model. Further, the risk feature description capable of being used to perform transaction risk determining can be determined based on importance of the risk transaction representation and the random transaction data in determining whether the risk transaction has a risk. It can be learned that the risk transaction representation in this solution is obtained based on transaction data that satisfy some risk feature descriptions, and the random transaction representation is obtained based on randomly obtained transaction data. In this way, degrees of importance of the risk transaction representation and the random transaction representation are significantly different, and the risk feature description capable of being used to perform transaction risk determining can be obtained based on this.

The following describes the steps in FIG. 1 with reference to one or more specific embodiments.

First, in step 101, the at least one group of risk transaction data for risk transaction prediction is obtained.

In this step, each group of obtained risk transaction data needs to satisfy one risk feature description. For example, “a transaction amount in recent seven days is not greater than 10000”, “quantities of transactions from 23:00 p.m. to 03:00 a.m. in recent 10 days are greater than 5”, “quantities of transaction places in recent five transactions are not greater than 3”, etc. are all different risk feature descriptions. Each group of risk transaction data is transaction data that satisfy one risk feature description, for example, a group of transaction data shown in Table 1 is a feature description that satisfies “a quantity of transaction places in recent two days is equal to 1”.

TABLE 1

| | | | |
|---|---|---|---|
| 07:04:25 on Jan. 1, 2022 | Pay | 3.4 | Shanghai |
| 08:12:22 on Jan. 2, 2022 | Change a | | Hangzhou |
| | password | | |
| 15:25:40 on Jan. 3, 2022 | Pay | 120 | Hangzhou |
| 21:48:46 on Jan. 4, 2022 | Collect | 9.9 | Hangzhou |

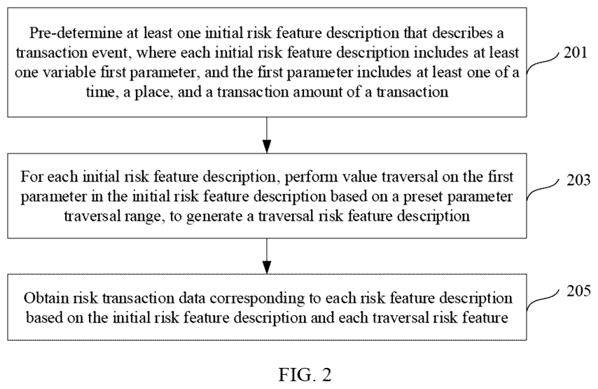

In a possible implementation, as shown in FIG. 2, the step 101 of obtaining at least one group of risk transaction data for risk transaction prediction can be implemented by using the following steps: Step 201: Pre-determine at least one initial risk feature description that describes a transaction event, where each initial risk feature description includes at least one variable first parameter, and the first parameter includes at least one of a time, a place, and a transaction amount of a transaction. Step 203: For each initial risk feature description, perform value traversal on the first parameter in the initial risk feature description based on a preset parameter traversal range, to generate a traversal risk feature description. Step 205: Obtain risk transaction data corresponding to each risk feature description based on the initial risk feature description and each traversal risk feature description.

In this embodiment, when the risk transaction data for risk transaction prediction are obtained, at least one initial risk feature description that describes the transaction event can be first determined in advance. The initial risk transaction feature description includes the variable first parameter. Then, for each initial risk feature description, value traversal is performed on the first parameter included in the initial risk feature description, to generate the traversal risk feature description. Finally, the risk transaction data corresponding to each risk feature description can be obtained based on the initial risk feature description and the generated traversal risk feature description. In this way, at least one risk feature description is pre-determined, and the risk feature description is generated in a parameter traversal manner, to ensure that coverage of the risk feature description is more comprehensive, and a guarantee is also provided for interpretability of risk determining.

The following describes step 201.

When the initial risk feature description is determined, the initial feature description needs to include at least one variable first parameter, and the first parameter can include a transaction time, a place, a transaction amount, etc. For example, the determined initial risk-feature description can be “a quantity of cities of transactions in recent seven days”, or “the sum of payment amounts in one recent month”. In these feature descriptions, for example, seven days, a quantity of cities, one month, and a payment amount are all variable first parameters.

The following describes step 203.

After the initial risk feature description is determined, it is considered that parameter value traversal is performed on the first parameter in the determined risk feature description in a specific range, to obtain more risk feature descriptions. Therefore, the risk feature description is more comprehensive, and a guarantee can also be provided for interpreting determining of the risk transaction.

For example, for the initial risk feature description “a quantity of cities of transactions in recent seven days”, a first parameter included in the first risk feature description can be a parameter such as recent seven days or cities. During traversal, the recent seven days can be changed to recent three days, recent 14 days, one recent month, a previous week, a previous month, etc. through traversal, and the place city can be changed to a province, a municipality, an autonomous region, etc. through traversal.

In this step, each time a parameter changes, a traversal risk feature description can be obtained. For example, “recent seven days” is changed to “one recent month” through traversal, to obtain a traversal risk feature description “a quantity of cities of transactions in one recent month”. For another example, “payment amount” in “the sum of payment amounts in recent 10 days is not greater than 1000” is changed to “collection amount”, to obtain a traversal risk feature description “the sum of collection amounts in recent 10 days is not greater than 1000”. For another example, when “payment amount” is changed to “collection amount”, “not greater than 1000” can also be changed to “not less than 500”, to obtain a traversal risk feature description “the sum of collection amounts in the recent 10 days is not less than 500”.

Certainly, it is easily understood that, during traversal, the first parameter needs to satisfy the preset traversing range, to ensure that the obtained risk feature description is reasonable. For example, there are 34 provincial administrative regions in China. Clearly, a traversal range of a quantity of provincial administrative regions needs to be not be greater than 34.

The following describes step 205.

After the initial risk feature description and the traversal risk feature description are determined, the risk transaction data that satisfy each risk feature description can be obtained based on these risk feature descriptions. When the risk transaction data are obtained based on the initial risk feature description and the traversal risk feature description, the risk transaction data can be mainly obtained in two manners: Manner 1: In this manner, it is considered that the risk transaction data are randomly generated. For example, risk transaction data that satisfy the initial risk feature description can be randomly generated. Risk transaction data that satisfy the traversal risk feature description can also be randomly generated. Because the risk transaction data obtained in this manner are randomly generated, the obtained risk transaction data have wider coverage. In addition, in this manner, the risk transaction data are generated based on the risk feature description, and the obtained risk transaction data more accurately satisfy the risk feature description.

Manner 2: It is considered that a data query can be performed on a database system based on an SQL statement. Therefore, in this manner, the initial risk feature description and the traversal risk feature description can be first converted into SQL statements, and then risk transaction data that satisfy various risk feature descriptions are found from a transaction database based on the SQL statement. In this solution, through a query means of the SQL statement, the risk transaction data that satisfy various risk feature descriptions can be quickly and efficiently found by merely converting various risk feature descriptions into SQL statements. In addition, the entire transaction database can be queried based on the SQL statement, so that the obtained risk transaction data is more comprehensive, to improve accuracy of extracting the risk feature description capable of being used to perform risk transaction determining.

In addition, the risk feature descriptions are usually in several relatively specified formats, for example, time+place+amount, which is very easy to be converted into an SQL statement. Therefore, a manner of obtaining the risk transaction data through an SQL query is more convenient and simpler, and a large amount of time can be saved.

Then, in step 103, the at least one group of random transaction data is obtained from the transaction record data of the historical risk control event.

The random transaction data can be obtained through random sampling from transaction records of the historical risk control event. For example, several groups of transaction sequence samples can be obtained through randomly sampling from a transaction sequence of several accounts in recent one year, and are used as random transaction data.

Further, in step 105, the at least one group of risk transaction data and the at least one group of random transaction data are separately input into the pre-trained risk transaction prediction model, to obtain the at least one risk transaction representation corresponding to the risk transaction data and the at least one random transaction representation corresponding to the random transaction data that are output by the first neuron layer of the risk transaction prediction model.

The risk transaction prediction model is a model used to predict whether a transaction has a risk in a prevention and control scenario, and is obtained through training based on several groups of sample training sets. Each group of sample training sets can include at least one risk feature and a label that identifies whether the risk feature has a risk.

In this step, it is considered that the at least one group of obtained risk transaction data is input into the risk transaction prediction model, to obtain the at least one risk transaction representation output by the first neuron layer of the risk transaction prediction model. The at least one group of obtained random transaction data are input into the risk transaction prediction model, to obtain the at least one random transaction representation output by the first neuron layer of the risk transaction prediction model. In this way, abstract representations corresponding to the risk transaction data and the random transaction data can be obtained, to help classify the risk transaction representation and the random transaction representation into different spaces subsequently.

It should be noted that the first neuron layer is not the output layer of the risk transaction prediction model, but the first neuron layer needs to be closer to the output layer of the risk transaction prediction model. When the first neuron layer is closer to the output layer of the risk transaction prediction model, an obtained representation is more abstract, and feature information corresponding to the representation is more comprehensive. Therefore, when representations are distinguished subsequently, the risk transaction representation and the random transaction representation can be more accurately classified into two different spaces.

Finally, in step 107, the risk feature description capable of being used to perform transaction risk determining in all the risk feature descriptions is determined based on the importance of the at least one risk transaction representation and the at least one random transaction representation in determining whether the risk transaction has a risk.

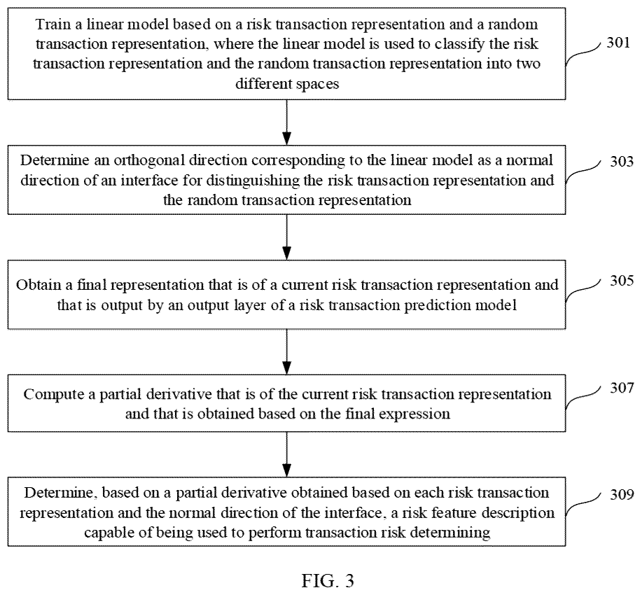

In this step, after the risk transaction representation and the random transaction representation that are output by the risk transaction prediction model are obtained, the risk feature description is determined in consideration of the degrees of importance of the representations in determining whether the risk transaction has a risk. For example, in a possible implementation, as shown in FIG. 3, step 107 can include the following steps: Step 301: Train a linear model based on the risk transaction representation and the random transaction representation, where the linear model is used to classify the risk transaction representation and the random transaction representation into two different spaces. Step 303: Determine an orthogonal direction corresponding to the linear model as a normal direction of an interface for distinguishing the risk transaction representation and the random transaction representation. For each of the risk transaction representations, step 305 and step 307 are performed: Step 305: Obtain a final representation that is of a current risk transaction representation and that is output by the output layer of the risk transaction prediction model. Step 307: Compute a partial derivative that is of the current risk transaction representation and that is obtained based on the final expression. Step 309: Determine, based on a partial derivative obtained based on each risk transaction representation and the normal direction of the interface, a risk feature description capable of being used to perform transaction risk determining.

In this embodiment, when the risk feature description capable of being used to perform transaction risk determining in all the risk feature descriptions is determined, a linear model can be trained based on the risk transaction representation and the random transaction representation. Then, the normal direction of the interface for distinguishing the risk transaction representation and the random transaction representation is determined based on the linear model. Further, for each risk transaction representation, a final expression output by the output layer of the risk transaction prediction model is obtained, and a partial derivative that is of the risk transaction representation and that is obtained based on the final expression is computed. Finally, the risk feature description capable of being used to perform transaction risk determining can be determined based on the partial derivative obtained based on each risk transaction representation and the normal direction of the interface.

Because the partial derivative can measure a change rate of a function, in this embodiment, a partial derivative of the risk transaction representation is obtained based on the final expression, to obtain a direction that enables the final expression of the risk transaction representation to become larger most quickly. A larger output value obtained based on the final expression indicates that the model considers a larger probability that the risk transaction representation has a transaction risk in the future. Therefore, a direction of the partial derivative is a direction in which the risk transaction representation is most sensitive to a risk in the future. Therefore, accuracy of the interpretable risk feature description can be improved based on the partial derivative and the normal direction of the interface.

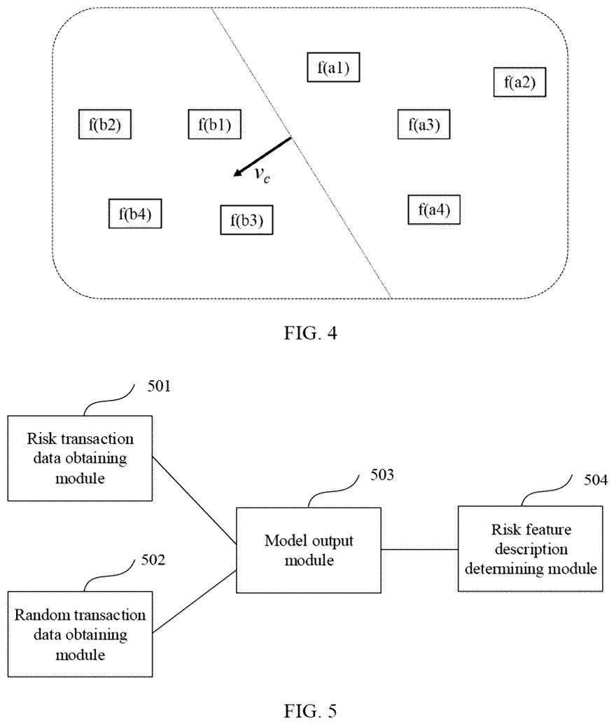

In step 301, it is considered that the linear model is trained based on the risk transaction representation and the random transaction representation. The linear model is used to classify the risk transaction representation and the random transaction representation into two different spaces. As shown in FIG. 4, random transaction representations f(a1), f(a2), f(a3), f(a4) and risk transaction representations f(b1), f(b2), f(b3), and f(b4) are classified into two different spaces by a linear model Y. It is easily understood that a curve corresponding to the linear model Y is an interface for distinguishing the risk transaction representation and the random transaction representation.

In step 303, after the linear model is determined, or after the interface for distinguishing the risk transaction representation and the random transaction representation is determined, it is considered that the orthogonal direction corresponding to the linear model is determined, and the orthogonal direction corresponding to the linear model is determined as the normal direction of the interface for distinguishing the risk transaction representation and the random transaction representation. As shown in FIG. 4, a direction indicated by an arrow in the figure is the normal direction of the interface, and the direction of the interface usually points to a direction in which the risk transaction represents is located.

After obtaining the final expression that is of the current risk transaction representation and that is output by the output layer of the risk transaction prediction model in step 305, it is considered in step 307 that the partial derivative that is of the risk transaction representation and that is obtained based on the final expression output by the output layer of the risk transaction prediction model is computed. Specifically, the following computing formula can be considered for computing:

$$S = ∇ h ( f ( x ) )$$

S is used to represent the partial derivative that is of the current risk transaction representation and that is obtained based on the final expression of the current risk transaction representation, h is used to represent the final expression of the current risk transaction representation, f(x) is used to represent the current risk transaction representation, and x is used to represent a risk feature description corresponding to the current risk transaction representation.

After the normal direction of the interface and the partial derivative of each risk transaction representation are obtained, it is considered in step 309 that the risk feature description capable of being used to perform transaction risk determining is determined based on the partial derivative obtained based on each risk transaction representation and the normal direction of the interface. In a possible implementation, whether a direction of the partial derivative obtained based on each risk transaction representation is consistent with the normal direction of the interface can be separately determined first. If a direction of a partial derivative obtained based on a risk transaction representation is consistent with the normal direction of the interface, a risk feature description corresponding to the risk transaction representation can be determined as a risk feature description capable of being used to perform transaction risk determining.

In a possible implementation, point multiplication of the partial derivative obtained based on each risk transaction representation and the normal direction of the partition interface can be computed, so that whether the risk feature description corresponding to the risk transaction representation is capable of being used to perform transaction risk determining is determined based on whether a value of a point multiplication result is a positive number or a negative number. In this embodiment, the normal direction of the interface can point to the direction of the space in which the risk transaction representation is located. The normal direction of the interface is the direction of the risk feature transaction representation corresponding to the risk feature description. If the direction of the partial derivative is the same as the direction of the risk feature transaction representation corresponding to the risk feature description, it indicates that the risk feature description is a sensitive factor that causes the risk transaction prediction model to determine that the risk transaction data have a risk. That is, if the point multiplication result is a positive number, it indicates that the risk feature description corresponding to the risk transaction representation is important for the risk transaction prediction model to determine that the risk transaction data have a risk. Therefore, a risk feature description corresponding to the risk transaction representation can be determined as a risk feature description capable of being used to perform risk determining.

In addition, that the risk feature description is capable of being used to perform transaction risk determining can be further determined through mathematical statistics. For example, for each risk transaction representation, the above-mentioned point multiplication value S(x) is computed based on the following computing formula:

$$S ( x ) = ∇ h ( f ( x ) ) \cdot {v}_{c}$$

In the point multiplication value S(x) obtained for each risk transaction representation, only a sign of the point multiplication value, that is, whether the sign of the point multiplication value is positive, needs to be paid attention to. Then, a proportion of positive numbers to values of S(x) of all risk transaction representations is counted, and is denoted as Tₛ. Tₛ can be computed based on the following computing formula:

$${T}_{s} = \frac{\vert \{ x ∈ {X}_{k} : S ( x ) > 0 \} \vert}{\vert {X}_{k} \vert}$$

Here, Xₖ is used to represent a set of risk feature descriptions, and x is the risk feature description. In the computing formula, a numerator part represents a risk feature description whose sign of S(x) is a positive number in all risk feature descriptions, and a denominator part represents all the risk feature descriptions.

If a risk feature description is very important for the risk transaction prediction model to determine the risk transaction, a value of Tₛ of the risk transaction representation needs to be greater than Tₛ of the random transaction representation. Therefore, for the random transaction representation, a value of Tₛ can also be computed based on the above-mentioned computing formula. The risk feature description can be determined by comparing the risk transaction representation and the random transaction representation.

Certainly, a t test can be further performed on Tₛ of the obtained risk transaction representation and Tₛ of the obtained random transaction representation, to determine whether there is a statistical difference between the two average values. If there is relatively high statistical significance, it indicates that the risk feature description corresponding to the risk transaction representation is a very important factor for the risk transaction prediction model to determine whether the risk transaction data have a risk.

As shown in FIG. 5, one or more embodiments of this specification further provide a risk feature description extraction apparatus, including: a risk transaction data obtaining module 501, a random transaction data obtaining module 502, a model output module 503, and a risk feature description determining module 504. The risk transaction data obtaining module 501 is configured to obtain at least one group of risk transaction data for risk transaction prediction. Each group of risk transaction data satisfy one risk feature description. The random transaction data obtaining module 502 is configured to obtain at least one group of random transaction data from transaction record data of a historical risk control event. The model output module 503 is configured to separately input the at least one group of risk transaction data obtained by the risk transaction data obtaining module 501 and the at least one group of random transaction data obtained by the random transaction data obtaining module 502 into a pre-trained risk transaction prediction model, to obtain at least one risk transaction representation corresponding to the risk transaction data and at least one random transaction representation corresponding to the random transaction data that are output by a first neuron layer of the risk transaction prediction model, where the risk transaction prediction model is used to predict whether a transaction has a risk, and the first neuron layer is not an output layer of the risk transaction prediction model. The risk feature description determining module 504 is configured to determine, based on importance of the at least one risk transaction representation and the at least one random transaction representation that are output by the model output module 503 in determining whether a risk transaction has a risk, a risk feature description capable of being used to perform transaction risk determining in all risk feature descriptions.

In a possible implementation, when obtaining the at least one group of risk transaction data for risk transaction prediction, the risk transaction data obtaining module 501 is configured to perform the following operations: pre-determining at least one initial risk feature description that describes a transaction event, where each initial risk feature description includes at least one variable first parameter, and the first parameter includes at least one of a time, a place, and a transaction amount of a transaction; for each initial risk feature description, performing value traversal on the first parameter in the initial risk feature description based on a preset parameter traversal range, to generate a traversal risk feature description; and obtaining risk transaction data corresponding to each risk feature description based on the initial risk feature description and each traversal risk feature description.

In a possible implementation, when obtaining the risk transaction data corresponding to each risk feature description based on the initial risk feature description and each traversal risk feature description, the risk transaction data obtaining module 501 is configured to perform the following operations: converting the initial risk feature description and the traversal risk feature description into an SQL statement; and querying a transaction database based on the SQL statement, to obtain risk transaction data that satisfy each risk feature description.

In a possible implementation, when obtaining the risk transaction data corresponding to each risk feature description based on the initial risk feature description and each traversal risk feature description, the risk transaction data obtaining module 501 is configured to perform the following operations: randomly generating risk transaction data that satisfy the initial risk feature description; and randomly generating risk transaction data that satisfy the traversal risk feature description.

In a possible implementation, when determining, based on the importance of the at least one risk transaction representation and the at least one random transaction representation in determining whether a risk transaction has a risk, a risk feature description capable of being used to perform transaction risk determining in all risk feature descriptions, the risk feature description determining module 504 is configured to perform the following operations: training a linear model based on the risk transaction representation and the random transaction representation, where the linear model is used to classify the risk transaction representation and the random transaction representation into two different spaces; determining an orthogonal direction corresponding to the linear model as a normal direction of an interface for distinguishing the risk transaction representation and the random transaction representation; and for each of the risk transaction representations, performing the following operations: obtaining a final representation that is of a current risk transaction representation and that is output by the output layer of the risk transaction prediction model; computing a partial derivative that is of the current risk transaction representation and that is obtained based on the final expression; and determining, based on a partial derivative obtained based on each risk transaction representation and the normal direction of the interface, a risk feature description capable of being used to perform transaction risk determining.

In a possible implementation, when computing the partial derivative that is of the current risk transaction representation and that is obtained based on the final expression, the risk feature description determining module 504 is configured to compute, based on the following computing formula, the partial derivative that is of the current risk transaction representation and that is obtained based on the final expression:

$$S = ∇ h ( f ( x ) )$$

S is used to represent the partial derivative that is of the current risk transaction representation and that is obtained based on the final expression of the current risk transaction representation, h is used to represent the final expression of the current risk transaction representation, f(x) is used to represent the current risk transaction representation, and x is used to represent a risk feature description corresponding to the current risk transaction representation.

In a possible implementation, the normal direction of the interface points to a direction of a space in which the risk transaction representation is located; and when determining, based on the partial derivative obtained based on each risk transaction representation and the normal direction of the interface, the risk feature description capable of being used to perform transaction risk determining, the risk feature description determining module 504 is configured to perform the following operations: separately determining whether a direction of the partial derivative obtained based on each risk transaction representation is consistent with the normal direction of the interface; and if a direction of a partial derivative obtained based on a risk transaction representation is consistent with the normal direction of the interface, determining a risk feature description corresponding to the risk transaction representation as a risk feature description capable of being used to perform transaction risk determining.

This specification further provides a computer-readable storage medium. The computer-readable storage medium stores a computer program, and when the computer program is executed on a computer, the computer is enabled to perform the method according to any embodiment of this specification.

This specification further provides a computing device, including a memory and a processor. The memory stores executable code, and when the processor executes the executable code, the method in any embodiment of this specification is implemented.

It can be understood that the structure illustrated in one or more embodiments of this specification does not constitute a specific limitation on the risk feature description extraction apparatus. In some other embodiments of this specification, the risk feature description extraction apparatus can include more or fewer components than those shown in the figure, or combine some components, or split some components, or have different component arrangements. The components in the figure can be implemented by hardware, software, or a combination of software and hardware.

Content such as information exchange and execution processes between units in the previous apparatus is based on the same concept as that in the method embodiment of this specification. For specific content, references can be made to the description in the method embodiment of this specification. Details are omitted here for simplicity.

A person skilled in the art should be aware that in the above-mentioned one or more examples, functions described in this specification can be implemented by hardware, software, firmware, or any combination thereof. When the functions are implemented by software, the above-mentioned functions can be stored in a computer-readable medium or transmitted as one or more instructions or code in the computer-readable medium.

In the above-mentioned specific implementations, the objectives, technical solutions, and beneficial effects of this specification are further described in detail. It should be understood that the above-mentioned descriptions are merely specific implementations of the present invention, but are not intended to limit the protection scope of the present invention. Any modification, equivalent replacement, improvement, or the like made based on the technical solutions of the present invention shall fall within the protection scope of the present invention.

1. A risk feature description extraction method, comprising:
obtaining at least one group of risk transaction data for risk transaction prediction, wherein each group of risk transaction data satisfy one risk feature description;
obtaining at least one group of random transaction data from transaction record data of a historical risk control event;
separately inputting the at least one group of risk transaction data and the at least one group of random transaction data into a pre-trained risk transaction prediction model, to obtain at least one risk transaction representation corresponding to the risk transaction data and at least one random transaction representation corresponding to the random transaction data that are output by a first neuron layer of the risk transaction prediction model, wherein the risk transaction prediction model is used to predict whether a transaction has a risk, and the first neuron layer is not an output layer of the risk transaction prediction model; and
determining, based on importance of the at least one risk transaction representation and the at least one random transaction representation in determining whether a risk transaction has a risk, a risk feature description capable of being used to perform transaction risk determining in all risk feature descriptions.

2. The method according to claim 1, wherein the obtaining at least one group of risk transaction data for risk transaction prediction comprises:
pre-determining at least one initial risk feature description that describes a transaction event, wherein each initial risk feature description comprises at least one variable first parameter, and a first parameter comprises at least one of a time, a place, and a transaction amount of a transaction;
for each initial risk feature description, performing value traversal on the first parameter in an initial risk feature description based on a preset parameter traversal range, to generate a traversal risk feature description; and
obtaining risk transaction data corresponding to each risk feature description based on the initial risk feature description and each traversal risk feature description.

3. The method according to claim 2, wherein the obtaining risk transaction data corresponding to each risk feature description based on the initial risk feature description and each traversal risk feature description comprises:
converting the initial risk feature description and the traversal risk feature description into an SQL statement; and
querying a transaction database based on the SQL statement, to obtain risk transaction data that satisfy each risk feature description;
and/or randomly generating risk transaction data that satisfy the initial risk feature description; and
randomly generating risk transaction data that satisfy the traversal risk feature description.

4. The method according to claim 1, wherein the determining, based on importance of the at least one risk transaction representation and the at least one random transaction representation in determining whether a risk transaction has a risk, a risk feature description capable of being used to perform transaction risk determining in all risk feature descriptions comprises:
training a linear model based on the risk transaction representation and the random transaction representation, wherein the linear model is used to classify the risk transaction representation and the random transaction representation into two different spaces;
determining an orthogonal direction corresponding to the linear model as a normal direction of an interface for distinguishing the risk transaction representation and the random transaction representation; and
for each of the risk transaction representations, performing the following operations:
obtaining a final representation that is of a current risk transaction representation and that is output by the output layer of the risk transaction prediction model;
computing a partial derivative that is of the current risk transaction representation and that is obtained based on the final expression; and
determining, based on a partial derivative obtained based on each risk transaction representation and the normal direction of the interface, a risk feature description capable of being used to perform transaction risk determining.

5. The method according to claim 4, wherein the computing a partial derivative that is of the current risk transaction representation and that is obtained based on the final expression comprises:
computing, based on the following computing formula, the partial derivative that is of the current risk transaction representation and that is obtained based on the final expression:
$$S = ∇ h ( f ( x ) )$$
S is used to represent the partial derivative that is of the current risk transaction representation and that is obtained based on the final expression of the current risk transaction representation, h is used to represent the final expression of the current risk transaction representation, f(x) is used to represent the current risk transaction representation, and x is used to represent a risk feature description corresponding to the current risk transaction representation.

6. The method according to claim 4, wherein the normal direction of the interface points to a direction of a space in which the risk transaction representation is located; and
the determining, based on a partial derivative obtained based on each risk transaction representation and the normal direction of the interface, a risk feature description capable of being used to perform transaction risk determining comprises:
separately determining whether a direction of the partial derivative obtained based on each risk transaction representation is consistent with the normal direction of the interface; and
upon determining that a direction of a partial derivative obtained based on a risk transaction representation is consistent with the normal direction of the interface, determining a risk feature description corresponding to the risk transaction representation as a risk feature description capable of being used to perform transaction risk determining.

7-8. (canceled)

9. A computing device, comprising a memory and a processor, wherein the memory stores executable code, and when executing the executable code, the processor is caused to:
obtain at least one group of risk transaction data for risk transaction prediction, wherein each group of risk transaction data satisfy one risk feature description;
obtain at least one group of random transaction data from transaction record data of a historical risk control event;
separately input the at least one group of risk transaction data and the at least one group of random transaction data into a pre-trained risk transaction prediction model, to obtain at least one risk transaction representation corresponding to the risk transaction data and at least one random transaction representation corresponding to the random transaction data that are output by a first neuron layer of the risk transaction prediction model, wherein the risk transaction prediction model is used to predict whether a transaction has a risk, and the first neuron layer is not an output layer of the risk transaction prediction model; and
determine, based on importance of the at least one risk transaction representation and the at least one random transaction representation in determining whether a risk transaction has a risk, a risk feature description capable of being used to perform transaction risk determining in all risk feature descriptions.

10. A non-transitory computer-readable storage medium, wherein the computer-readable storage medium stores a computer program, and when the computer program is executed on a computer, the computer is enabled to perform:
obtain at least one group of risk transaction data for risk transaction prediction, wherein each group of risk transaction data satisfy one risk feature description;
obtain at least one group of random transaction data from transaction record data of a historical risk control event;
separately input the at least one group of risk transaction data and the at least one group of random transaction data into a pre-trained risk transaction prediction model, to obtain at least one risk transaction representation corresponding to the risk transaction data and at least one random transaction representation corresponding to the random transaction data that are output by a first neuron layer of the risk transaction prediction model, wherein the risk transaction prediction model is used to predict whether a transaction has a risk, and the first neuron layer is not an output layer of the risk transaction prediction model; and
determine, based on importance of the at least one risk transaction representation and the at least one random transaction representation in determining whether a risk transaction has a risk, a risk feature description capable of being used to perform transaction risk determining in all risk feature descriptions.

11. The computing device according to claim 9, wherein the computing device being caused to obtain at least one group of risk transaction data for risk transaction prediction includes being caused to:
pre-determine at least one initial risk feature description that describes a transaction event, wherein each initial risk feature description comprises at least one variable first parameter, and a first parameter comprises at least one of a time, a place, and a transaction amount of a transaction;
for each initial risk feature description, perform value traversal on the first parameter in an initial risk feature description based on a preset parameter traversal range, to generate a traversal risk feature description; and
obtain risk transaction data corresponding to each risk feature description based on the initial risk feature description and each traversal risk feature description.

12. The computing device according to claim 11, wherein the computing device being caused to obtain risk transaction data corresponding to each risk feature description based on the initial risk feature description and each traversal risk feature description includes being caused to:
convert the initial risk feature description and the traversal risk feature description into an SQL statement; and
query a transaction database based on the SQL statement, to obtain risk transaction data that satisfy each risk feature description;
and/or
randomly generate risk transaction data that satisfy the initial risk feature description; and
randomly generate risk transaction data that satisfy the traversal risk feature description.

13. The computing device according to claim 9, wherein the computing device being caused to determine, based on importance of the at least one risk transaction representation and the at least one random transaction representation in determining whether a risk transaction has a risk, a risk feature description capable of being used to perform transaction risk determining in all risk feature descriptions includes being caused to:
train a linear model based on the risk transaction representation and the random transaction representation, wherein the linear model is used to classify the risk transaction representation and the random transaction representation into two different spaces;
determine an orthogonal direction corresponding to the linear model as a normal direction of an interface for distinguishing the risk transaction representation and the random transaction representation; and
for each of the risk transaction representations, perform the following operations:
obtain a final representation that is of a current risk transaction representation and that is output by the output layer of the risk transaction prediction model;
compute a partial derivative that is of the current risk transaction representation and that is obtained based on the final expression; and
determine, based on a partial derivative obtained based on each risk transaction representation and the normal direction of the interface, a risk feature description capable of being used to perform transaction risk determining.

14. The computing device according to claim 13, wherein the computing device being caused to compute a partial derivative that is of the current risk transaction representation and that is obtained based on the final expression includes being caused to:
compute, based on the following computing formula, the partial derivative that is of the current risk transaction representation and that is obtained based on the final expression:
$$S = ∇ h ( f ( x ) )$$
S is used to represent the partial derivative that is of the current risk transaction representation and that is obtained based on the final expression of the current risk transaction representation, h is used to represent the final expression of the current risk transaction representation, f(x) is used to represent the current risk transaction representation, and x is used to represent a risk feature description corresponding to the current risk transaction representation.

15. The computing device according to claim 13, wherein the normal direction of the interface points to a direction of a space in which the risk transaction representation is located; and
wherein the computing device being caused to determine, based on a partial derivative obtained based on each risk transaction representation and the normal direction of the interface, a risk feature description capable of being used to perform transaction risk determining includes being caused to:
separately determine whether a direction of the partial derivative obtained based on each risk transaction representation is consistent with the normal direction of the interface; and
upon determining that a direction of a partial derivative obtained based on a risk transaction representation is consistent with the normal direction of the interface, determine a risk feature description corresponding to the risk transaction representation as a risk feature description capable of being used to perform transaction risk determining.

16. The non-transitory computer-readable storage medium according to claim 10, wherein the computer being caused to obtain at least one group of risk transaction data for risk transaction prediction includes being caused to:
pre-determine at least one initial risk feature description that describes a transaction event, wherein each initial risk feature description comprises at least one variable first parameter, and a first parameter comprises at least one of a time, a place, and a transaction amount of a transaction;
for each initial risk feature description, perform value traversal on the first parameter in an initial risk feature description based on a preset parameter traversal range, to generate a traversal risk feature description; and
obtain risk transaction data corresponding to each risk feature description based on the initial risk feature description and each traversal risk feature description.

17. The non-transitory computer-readable storage medium according to claim 16, wherein the computer being caused to obtain risk transaction data corresponding to each risk feature description based on the initial risk feature description and each traversal risk feature description includes being caused to:
convert the initial risk feature description and the traversal risk feature description into an SQL statement; and
query a transaction database based on the SQL statement, to obtain risk transaction data that satisfy each risk feature description;
and/or randomly generate risk transaction data that satisfy the initial risk feature description; and
randomly generate risk transaction data that satisfy the traversal risk feature description.

18. The non-transitory computer-readable storage medium according to claim 10, wherein the computer being caused to determine, based on importance of the at least one risk transaction representation and the at least one random transaction representation in determining whether a risk transaction has a risk, a risk feature description capable of being used to perform transaction risk determining in all risk feature descriptions includes being caused to:
train a linear model based on the risk transaction representation and the random transaction representation, wherein the linear model is used to classify the risk transaction representation and the random transaction representation into two different spaces;
determine an orthogonal direction corresponding to the linear model as a normal direction of an interface for distinguishing the risk transaction representation and the random transaction representation; and
for each of the risk transaction representations, perform the following operations:
obtain a final representation that is of a current risk transaction representation and that is output by the output layer of the risk transaction prediction model;
compute a partial derivative that is of the current risk transaction representation and that is obtained based on the final expression; and
determine, based on a partial derivative obtained based on each risk transaction representation and the normal direction of the interface, a risk feature description capable of being used to perform transaction risk determining.

19. The non-transitory computer-readable storage medium according to claim 18, wherein the computer being caused to compute a partial derivative that is of the current risk transaction representation and that is obtained based on the final expression includes being caused to:
compute, based on the following computing formula, the partial derivative that is of the current risk transaction representation and that is obtained based on the final expression:
$$S = ∇ h ( f ( x ) )$$
S is used to represent the partial derivative that is of the current risk transaction representation and that is obtained based on the final expression of the current risk transaction representation, h is used to represent the final expression of the current risk transaction representation, f(x) is used to represent the current risk transaction representation, and x is used to represent a risk feature description corresponding to the current risk transaction representation.

20. The non-transitory computer-readable storage medium according to claim 18, wherein the normal direction of the interface points to a direction of a space in which the risk transaction representation is located; and
wherein the computer being caused to determine, based on a partial derivative obtained based on each risk transaction representation and the normal direction of the interface, a risk feature description capable of being used to perform transaction risk determining includes being caused to:
separately determine whether a direction of the partial derivative obtained based on each risk transaction representation is consistent with the normal direction of the interface; and
upon determining that a direction of a partial derivative obtained based on a risk transaction representation is consistent with the normal direction of the interface, determine a risk feature description corresponding to the risk transaction representation as a risk feature description capable of being used to perform transaction risk determining.
